(19) United States
(12) Patent Application Publication
(10) Pub. No.: US 2011/0283201 A1
(43) Pub. Date: Nov. 17, 2011

(54) SYSTEM AND METHOD OF MATCHING DATES ON THE INTERNET

(76) Inventor: Edward Wachtel, New York, NY (US)

(21) Appl. No.: 12/778,349

(22) Filed: May 12, 2010

(51) Int. Cl. G06F 17/30; G06Q 99/00; G06Q 50/00; G06F 3/01

(52) U.S. Cl. 715/751; 707/758; 705/347; 707/E17.014

(57) ABSTRACT

A dating Internet site based computer system offers matchmakers to aid in the dating process. The system includes a client database to hold clients that wish to date and attributes of said clients. The system contains a matchmaker database that holds matchmakers, who are experts at personal relations. The client and matchmaker database information is used to provide potential clients with insight into whether a matchmaker will be of use to them, as well as information for the internet site to determine whether they should host a given matchmaker. Matchmakers can provide counseling and knowledge with regard to dating for pleasure and success.

### BACKGROUND OF THE INVENTION

The invention relates in general to an Internet based computer systems for matchmaking, and in particular, to a method of matching individuals for dating and marriage.

There are currently internet questionnaires that match individuals for dates. There are also profiles that individuals can use to decide on dates or search for dates. U.S. Pat. No. 6,272,467 describes a method of matching two sets of profiles. However, a person is much more complicated than a list of traits. Compounding this simplification, there will only be a subset of traits that will match with another set of traits in two profiles producing matches with limited information. In addition, opposites often attract. A talkative person may match with a quiet person. On the other hand, a person that loves parties and socializing may not match with a person that avoids social situations. A third person may not care one way or another about social situations. As can be seen the complexities of matching individuals exceeds matching of sets of traits.

Often date after date does not lead to a relationship desirable for one or both individuals involved. One may in fact choose individuals that are incompatible. A person from an abusive home may choose an abusive spouse. The divorce rate in America is quite large. Internet dating services often lead to a long string of incompatible dates. One's friends may know other single friends, but certainly a limited number and they too may be incompatible. A system and method is needed to better identify matches that will work, particularly for those interested in marriage. Further, it is desirable for dating to be pleasurable. Current methods often fall short or do not address at all methods of dating that make dating enjoyable.

### BRIEF SUMMARY OF THE INVENTION

An Internet site based computer system is described to match individuals for dating and marriage. The system includes a client database to hold clients that wish to date and attributes of the clients. The system contains a matchmaker database that holds matchmakers, who are experts at personal relations. The matchmaker database also contains statistics on client satisfaction, marriage and divorce. The client and matchmaker database information is used to provide potential clients with insight into whether a matchmaker will be of use to them, as well as information for the internet site to determine whether they should host a given matchmaker. Matchmakers can provide counseling and knowledge with regard to dating for pleasure and success.

In one embodiment there is described a method for matching dating individuals to matchmakers for the purpose of achieving the dating goals desired by the dating individuals, the method comprising providing at least one computer having at least one central processing unit; maintaining at least one database in the computer containing the identification of matchmakers that will review data on the dating individuals; maintaining the success of matchmakers in meeting dating individual goals and transforming the data by the central processing unit into a list of matchmakers for use by other dating individuals and, optionally, coaching the dating individuals in meeting the short and long term goals of the dating individuals.

In a further embodiment there is described a system for matching dating individuals to matchmakers comprising at least one computer having at least one central processing unit and one or more databases accessible over the Internet; said one or more databases in the computer containing the identification of matchmakers that will review information on the dating individuals; said one or more databases in the computer containing profiles of the data individuals; and said one or more databases in the computer containing historical data on the success of matchmakers in meeting dating individual goals, the profiles, identification of matchmakers and historical information transformed by the central processing unit into a list of matchmakers for use by clients that wish to date.

In a further embodiment there is described a method of matching individuals for dating to matchmakers, the method comprising providing at least one computer having at least one central processing unit and a plurality of databases accessible over the internet; maintaining personal profiles for a plurality of individuals for dating in at least one personal profile database; maintaining matchmaker ratings for a plurality of matchmakers in at least one matchmaker ratings database; accessing over the internet by one of the individuals the matchmaker ratings for selecting one of the matchmakers; and selecting using the central processing unit coupled to the personal profile database and the matchmaker rating database, a match between the one of the individuals and one of the plurality of matchmakers based on questionnaire responses by the one or more individuals to a predetermined list of questions.

In a further embodiment there is described a method for creating a list of matchmakers for use by dating individuals or a matchmaker site, the method comprising providing at least one computer having at least one central processing unit; maintaining at least one database in the computer containing matchmaker identification and matchmaker historical data concerning past success at helping individuals with the dating process; transforming the matchmaker identification and the historical data by the central processing unit into a list of one or more matchmakers for use by a matchmaker site in choosing matchmakers for the site or for use by dating individuals in choosing a matchmaker to aid them in the dating process.

In a further embodiment there is described a system for creating a list of matchmakers for use in a dating process by dating individuals, comprising at least one computer having at least one central processing unit and at least one database accessible over the internet; the database containing the identification of matchmakers that will review information on the dating individuals; and the database containing matchmaker historical data concerning past success at helping dating individuals with the dating process, the identification of matchmakers and the historical data transformed by the central processing unit into a list of one or more matchmakers for use by a matchmaker site in choosing matchmakers for the site or for use by dating individuals in choosing a matchmaker to aid them in the dating process.

In a further embodiment there is described a method for selecting a matchmaker by a dating individual for aiding in choosing dates, the method comprising providing at least one computer having at least one central processing unit and at least one database accessible over the internet; maintaining matchmaker identifications for a plurality of matchmakers in at least one the database; maintaining matchmaker ratings for a plurality of matchmakers in at least one the database; accessing over the internet by one of the dating individuals the matchmakers to aid the dating individual in choosing dates; selecting using the central processing unit coupled to the matchmaker identification in the at least one database and the matchmaker ratings in the at least one database, a matchmaker based on ratings of the matchmakers.

It is an object of the invention to provide, for example, an Internet computer based system to match individuals for dating and possible marriage.

It is another object of the invention for the server, for example, to maintain and supply to clients matchmaker success rates for client satisfaction and marriage.

It is another object of the invention to provide, for example, client information to the matchmakers, so the matchmaker can make an insightful dating match.

It is another object of the invention to supply, for example, information to the clients to help to make dating enjoyable.

It is another object of the invention to help the client, for example, to avoid choosing the wrong person by supplying competent matchmakers from the database.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings.

FIG. 1 shows the client, server and database configuration over the Internet in accordance with one embodiment of the invention.

FIG. 2 shows an overview of the matchmaking process in accordance with one embodiment of the invention.

FIG. 3 shows a client personal profile in accordance with one embodiment of the invention.

FIG. 4 shows a goals menu choice in accordance with one embodiment of the invention

FIG. 5 shows a date rating questionnaire in accordance with one embodiment of the invention.

FIG. 6 shows client database tables in accordance with one embodiment of the invention.

FIG. 7 shows the questionnaire builder in accordance with one embodiment of the invention.

FIG. 8 shows questionnaire tables in accordance with one embodiment of the invention.

FIG. 9 shows the matchmaker database table in accordance with one embodiment of the invention.

FIG. 10 shows a matchmaker list presented to a client in accordance with one embodiment of the invention.

FIG. 11 shows matchmaker rating database tables in accordance with one embodiment of the invention.

FIG. 12 shows a marriage and possible divorce database table in accordance with one embodiment of the invention.

FIG. 13 shows a rating selection from the database tables in accordance with one embodiment of the invention.

FIG. 14 shows the choosing of attribute for matchmakers and attributes for clients to acquire matchmaker ratings.

FIG. 15 shows the choosing of those facets to be rated as well as the choosing of statistics.

FIG. 16 shows the processing of stored information to produce a set of matchmakers and associated attributes and ratings.

FIG. 17 shows the structure of statistic information.

### DETAILED DESCRIPTION

In describing the preferred embodiments of the invention illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

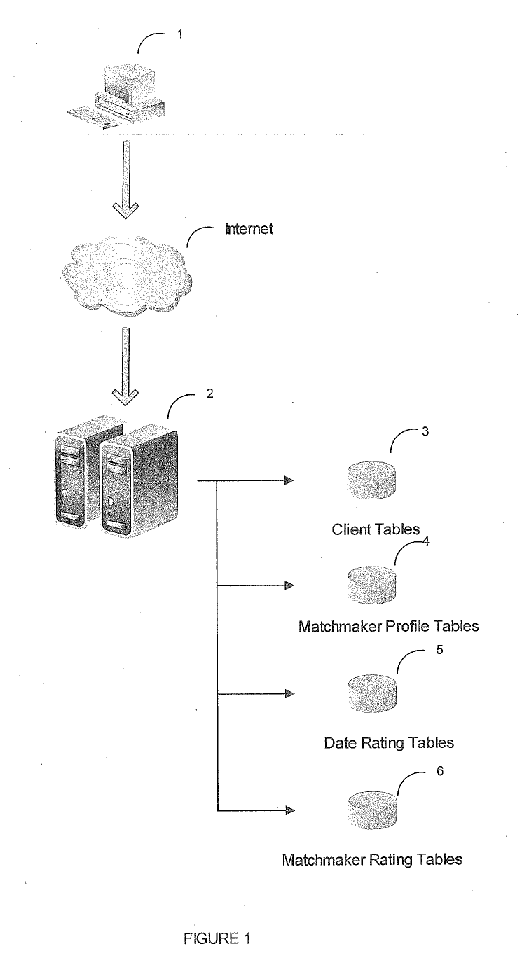

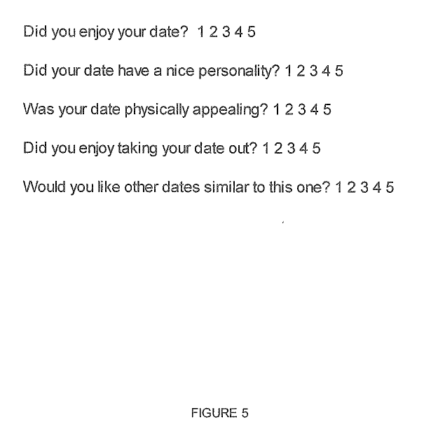

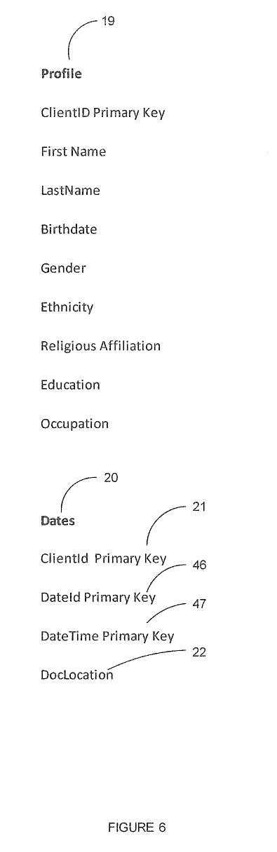

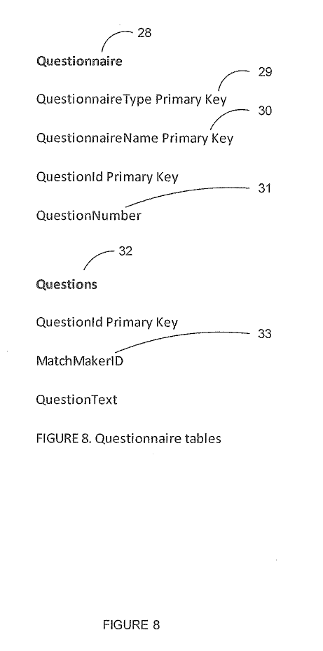

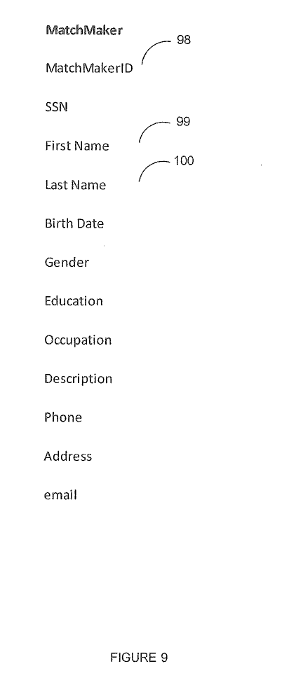

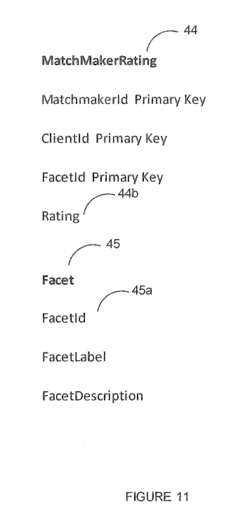

Referring to the drawings, FIG. 1 shows in accordance with one embodiment of the invention a preferred network structure of the invention. The network structure includes a set of clients on client system 1 such as microprocessor based system, e.g., a computer such as a PC or laptop, as well as other suitable systems such as PDAs, pocket PCs, cell phones and the like. The client system is connected through the Internet to server system 2 that accesses stored database tables such as client 3, matchmaker 4, date rating 5 and matchmaker rating 6 database tables. The server system 2 includes a microprocessor and one or more memory components. The Client Tables 3, shown in detail in FIG. 6, holds clients that wish to date, associated attributes of the clients, dating events and optional ratings of these dating events. The ratings of these dating events are generated from a date rating questionnaire, as shown in FIG. 5. The Matchmaker Profile Tables 4, shown in detail in FIG. 9, holds each matchmaker and associated attributes of each matchmaker. The Date Rating Tables 5, as detailed in FIG. 8, holds questionnaires generated by matchmakers to be filled out by dating individuals. Filled out questionnaires are stored in said dating events within said Client Tables 3. The Matchmaker Rating Tables 6, as detailed in FIG. 11, holds ratings of matchmakers by clients. For example dating individual George may rate matchmaker Susan, with regard to ‘meets my goals’ as a 9, from a span of 0 (terrible) to 10 (outstanding).

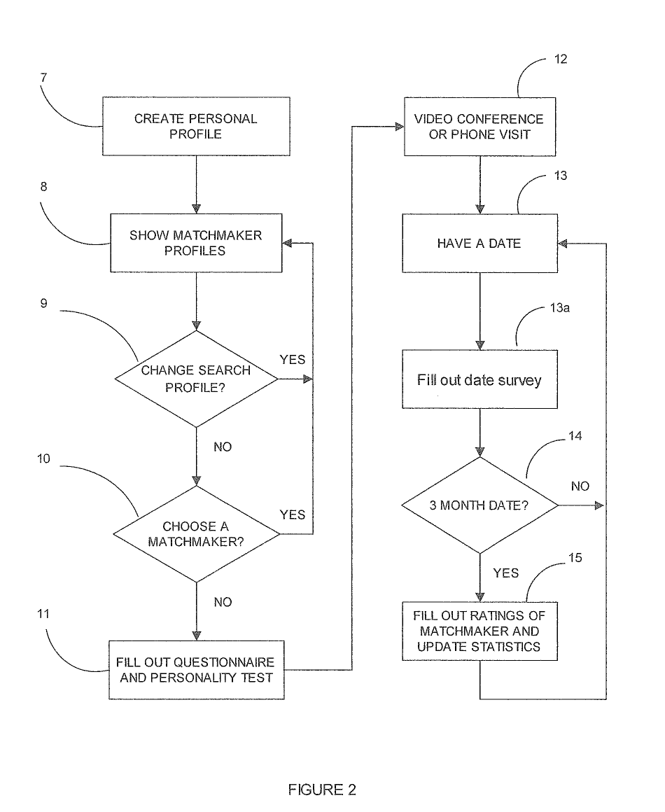

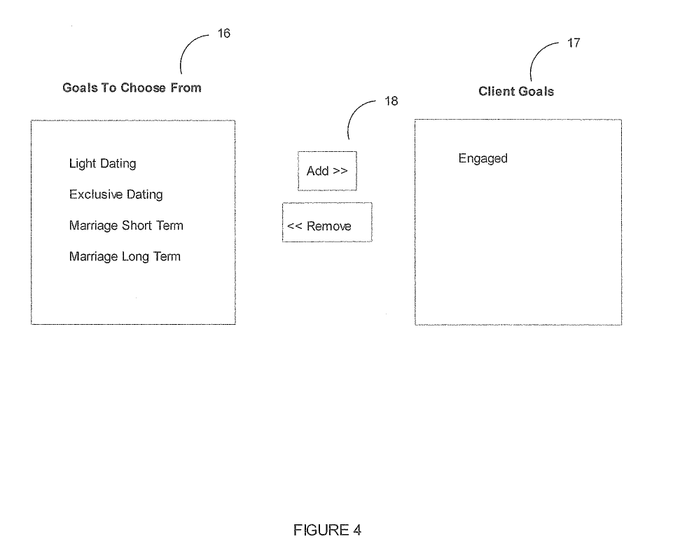

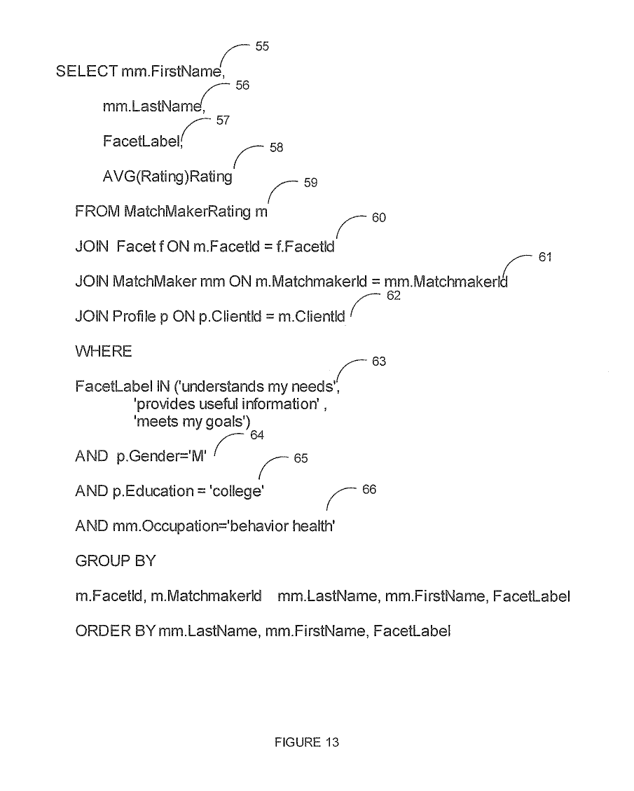

A flow diagram of the invention in accordance with one embodiment relating to a client seeking a date is shown in FIG. 2. In step 7, client A creates a personal profile through client system 1 which accesses server system 2 over the Internet. Said personal profile is stored in Client Tables 3, FIG. 1. The profile will typically contain age, gender, ethnicity, religious affiliation, education and occupation by way of examples. However, any other useful profile information can be included, such as hobbies or interests. Given these profile attributes of client A, server system 2 accesses stored database tables 3, 4, 6 with the select shown in FIG. 13 The select provides a set of matchmakers displayed in step 8 that have good ratings for clients with a similar profile. This select uses the central processing unit to transform base information from tables MatchMakerRating (Tables 6), Facet (Tables 6), MatchMaker (Tables 4), MatchMaker Profile (Tables 4) and Client Profile (Tables 3) into a list of recommended Matchmakers. This transformed data consisting of recommended matchmakers may also be used by the site to understand which matchmakers are productive. The select uses table MatchMakerRating stored in Matchmaker Rating Tables 6, Facet stored in Matchmaker Rating Tables 6, MatchMaker, stored in Matchmaker Profile Tables 4 and Profile stored in Client Tables 3. In step 9, the user can change the portion of their client profile used in determining the matchmakers. Once changed a new set of matchmakers is displayed in step 8. The client then chooses a matchmaker in step 10, which corresponds to a profile in Matchmaker Profile Tables 4. In step 11, the matchmaker chooses one or more client information requests such as a questionnaire and a personality test which the client fills out. The questionnaire is located in Client Tables 3 and is generated by choosing questions through a dialog box, as shown in FIG. 4. The personality test is a standard industry personality test and is stored on the fixed disk on server system 2. This gives the matchmaker information in choosing a date for the client. In step 12, the client has the option to have a video conference or phone visit with the matchmaker. The video conference flows between client system 1 through the Internet and to the matchmaker, either directly through the Internet or through server system 2. In step 13, the client has a date set up by the matchmaker. In step 14, if the client has been dating for 3 months, the client fills out matchmaker ratings in step 15, which are stored in matchmaker database 4. The client then continues dating or has the option to switch to a new matchmaker.

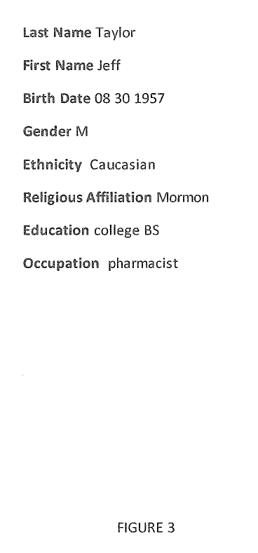

An example of a personal profile stored in Client Tables 3, created by the client from system 1 is shown in FIG. 3. The personal profile is used by the server system 2 to determine matchmakers to present to the client, as described in FIG. 2 step 8. The profile is also used by the matchmaker to determine suitable dates. FIG. 4 shows an optional client goals menu that may also be used by the matchmaker in choosing dates. These goals are stored in Client Tables 3. Selected ‘Client Goals’ 17 are added from ‘Goals To Choose From’ 16 by pressing the ‘Add’ 18 button.

An example of tables associated with the client that is dating is shown in FIG. 6. The profile 19 table contains attributes of the client and is generated in step 7 of FIG. 2 and is used in step 9. The dates 20 table contains each recorded date, filled out by the matchmaker in step 13 of FIG. 2, which consists of two clients ClientId 21 and the associated date client Dateld 46 and a DateTime 47. An optional rating document located in location DocLocation 22 is filled out by the client identified by ClientID 21 in step 13a of FIG. 2. This document is used by the matchmaker to determine the next date for the client identified by ClientID 21. This rating of a date is used with other date ratings from this client, other client information such as personality tests, along with other personal profiles located in tables 3, by the matchmaker to transform this information into a date recommendation for the client.

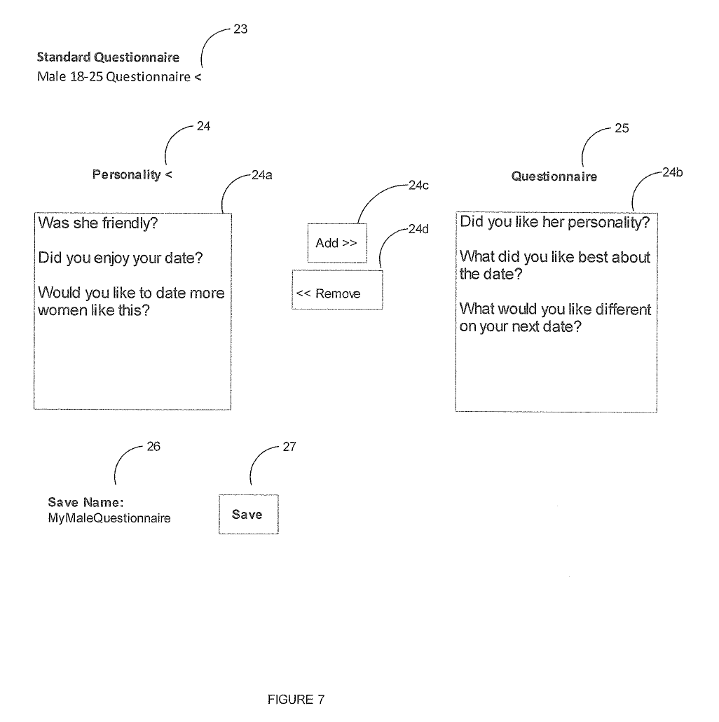

FIG. 5 shows an example of a date rating sheet to be answered by the client. This is step 13a of FIG. 2. The matchmaker picks the questions from tables shown in FIG. 8 using the questionnaire builder in FIG. 7. The questionnaire builder is run by the central processing unit and allows individualized questionnaires to be sent to a dating client. The questionnaire builder gives the matchmaker creative flexibility in obtaining information to choose dates. The matchmaker can, of course, have a teleconference instead or in addition to, a questionnaire. From the Standard Questionnaire drop down 23, the matchmaker can choose a prebuilt questionnaire. These questions immediately show up in the list 24a. The question type drop down 24 fills the list below 24a with that type of question. In this example, the questions in box 24a are generated by choosing Personality in dropdown 24 and Male 18-25 in dropdown 23. In this case, ‘Male 18-25’ may be a prebuilt questionnaire that all matchmakers have access to. The Add 24c and Remove 24d buttons move questions between the two lists of question type 24a and questionnaire 24b. If the questionnaire is modified from the standard questionnaire 23, it can be saved for this matchmaker using the Save Name 26 text box and pressing the Save button 27.

FIG. 8 shows the questionnaire tables. Questionnaire is tied to many questions from table Questions 32. These questions are stored in Date Rating Tables 5. For FIG. 7, QuestionnaireType 29 is ‘dating’. Thus, questions regarding dating will be listed in box 24a. Other questionnaire types can be defined. QuestionnaireName 30 shows up in the drop down list in FIG. 7 standard questionnaire. In FIG. 7, questionnaireName is ‘Male 18-25’ and is within the ‘dating’ group of questions. MatchMakerID 33 allows for per matchmaker built questions. If a questionnaire has a matchmaker created set of questions, a matchmaker specific Questionnaire Name 30 is created by filling in text box 26 and pressing the Save button, which will save questions listed in box 24b with the MatchMakerID 33 and Save Name 26. Save Name 26 can then be chosen in dropdown 23 and other dialogs requiring a Standard Questionnaire, such as the Date Rating sheet of FIG. 5. MatchMakerID 33 is set to ‘Site Matchmaker’ for questionnaires available to all matchmakers. Thus, a given matchmaker will have choices of ‘Site Matchmaker’ and their own MatchMakerID, which is associated with their own QuestionnaireName 30 questionnaires. For example, MatchMakerID 33 associated with matchmaker Jenny may have a set of questions that she likes to ask for college women graduates. She may add, by pressing Add button 24c, 10 questions from various Standard Questionnaire questions 23 and various question types 24 and name the QuestionnaireName 26 ‘Women College Graduates’, stored in QuestionnaireName 30 upon pressing the Save button. QuestionNumber 31 gives the order of the questions and is determined once Save 27 in FIG. 7 is pressed. For example, ‘Did you like her personality’ question in FIG. 7 would be the first question asked of the three questions shown in box 24b. Thus, questions from table 32 is transformed into questionnaires in table 28.

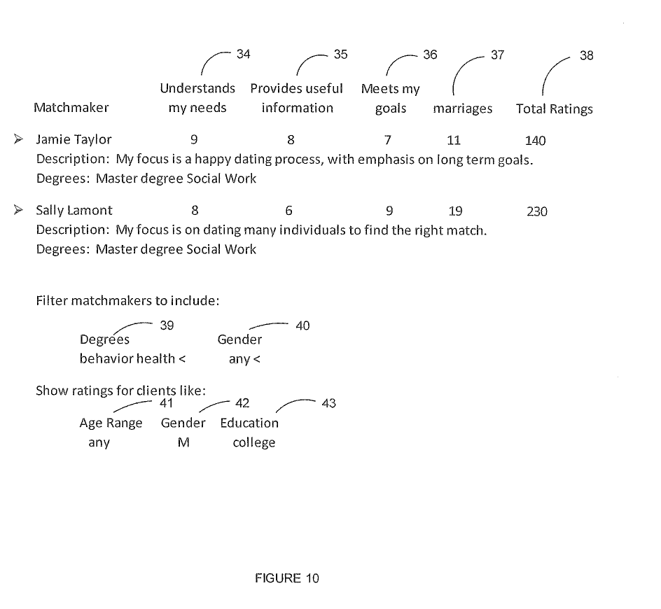

The matchmaker's profile is shown in FIG. 9 and is stored in Matchmaker Profile Tables 4. FIG. 10 shows a matchmaker list example. This list is shown to a client in step 10 of FIG. 2. Thus, a client that wants to date, might be shown ‘Jamie Taylor’ and ‘Sally Lamont’ as potential matchmakers, shown in FIG. 10. The client might choose ‘Jamie Taylor’ to be their matchmaker. The rating questions are ‘understands my needs’ 34, ‘provides useful information’ 35 and ‘meets my goals’ 36. Statistics kept are the number of marriages 37 and total ratings 38. For example, in this figure, ‘Jamie Taylor’ has an average rating of 9 for ‘Understands my needs’ from other clients that have used Jamie Taylor as their matchmaker. We can also keep the length of marriages and compare the average to the national average. The rating questions and statistics used 34, 35, 36, 37 and 38 in this example are the same for all matchmakers, allowing for equal comparison. Thus, rating information from each client and individual marriage statistics are brought together and transformed into a set of facet ratings for one or more matchmakers. In FIG. 10, the dating client selects whether the matchmaker should have a given Degree 39 or gender 40. This information is combined with the matchmaker profile (FIG. 9) and transformed by the central processing unit to generate a list of matchmakers for the client. In this figure, ‘Jamie Taylor’ and ‘Sally Lamont’ must have a behavior health degree. In this example, ratings of the matchmaker will be based off clients for any age range 41 that are gender 42 of male with a college education 43. Thus the ‘Understands my needs’ of rating 9 for ‘Jamie Taylor’ is an average rating from clients that have used ‘Jamie Taylor’ as their matchmaker and are male college graduates.

The tables for the matchmaker ratings are shown in FIG. 11. MatchMakerRating 44 contains all the ratings made by clients for all the matchmakers that have been used by clients. MatchMakerRating 44 contains a record for each matchmaker, client and facet combination. For example matchmaker Jamie Taylor, client Jeff Bridges, facet ‘meets my goals’ may have a rating of 7. This is one record. Matchmaker Jamie Taylor, client Jeff Bridges, facet ‘Understands my needs’ may have a rating of 9. This is another record. Matchmaker Sally Lamont, client Don Valdez, facet ‘Understands my needs’ may have a rating of 9. This is another example of a record. Averages of these records along with client profile attributes 19 are transformed by the central processing unit into data used to populate the screen shown in FIG. 10. For example, for ‘Jamie Taylor’ the average of the records for all male, college educated clients that have used Jamie Taylor as their matchmaker for facet ‘Understands my needs’ is 9.

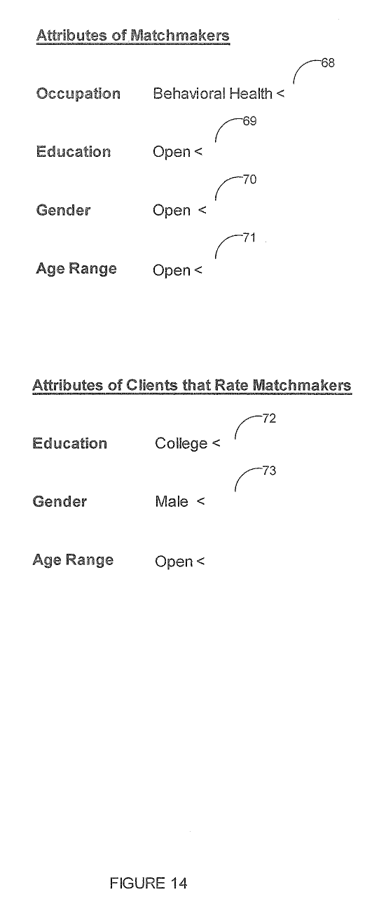

In FIG. 14 a client selects characteristics of matchmakers that he wants in a matchmaker. Default matchmaker characteristic values can be used for male and female clients based on highest chosen characteristics in the past for males and females. He also selects characteristics for clients that have used matchmakers, whose ratings will be used in determining the effectiveness of matchmakers. Default client characteristic values can be used for male and female clients based on highest chosen characteristics in the past for males and females or simply male clients for statistics for males and female clients for statistics for females. In this case the client wants to see information on matchmakers that have an occupation of ‘behavioral health’ 68. ‘behavior health’ is selected from a dropdown of possible occupations. He does not care about the education 69 gender 70 and age range 71 of the matchmaker. He wants ratings to be based off of ‘college educated’ 72 ‘male’ 73 clients. ‘male’ is selected from a dropdown containing ‘male’ and ‘female. ‘college educated’ is selected from a dropdown of education levels.

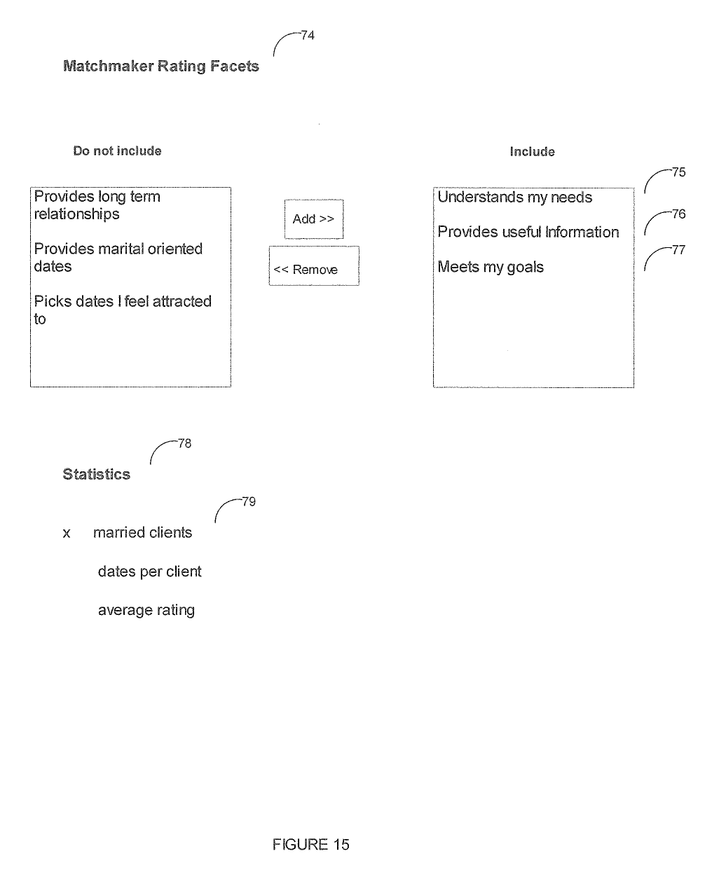

FIG. 15 allows a client to choose what rating facets about the matchmaker 74 and statistics 78 on matchmaker performance he would like to view. Default values can be chosen for male and female clients based on highest chosen characteristics in the past for males and females. Rating facets chosen are ‘understands my needs’ 75, ‘provides useful information’ 76 and ‘meets my goals’ 77. Statistics he is interested in are how many clients end up getting married, ‘married clients’ 79.

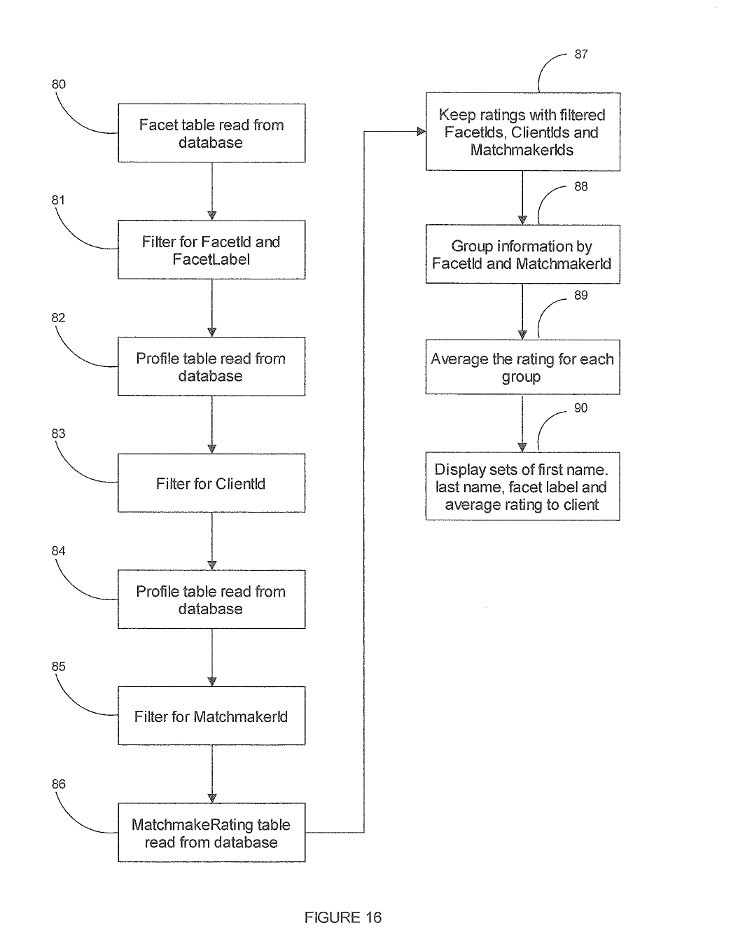

FIG. 16 shows a flow for the processing of: 1) gathered matchmaker ratings from clients that have used matchmakers FIG. 11, 2) matchmaker and client characteristics from clients that want to choose a matchmaker FIG. 14 3) stored matchmaker characterstics FIGS. 9 and 4) stored client characteristics FIG. 3. This processing results in a set of matchmakers that a client can choose from, along with associated history of ratings shown in FIG. 10.

The flow in FIG. 15 to produce the ratings results shown in FIG. 10 proceeds as follows. In step 80 Facet table 45 FIG. 11 is read from the database. In step 81 FacetId 45a and FacetLabel 45b are kept for FacetLabels 45b ‘understands my needs’ 70, ‘provides useful information’ 71 and ‘meets my goals’ 72. In step 82 client Profile table 19 FIG. 6 is read from the database. In step 83 ClientIds 19a are kept for records containing Education 19b of college educated and Gender 19c of male. In step 84 MatchMaker table FIG. 9 is read from the database and in step 85 MatchmakerIds 90a are kept that have an occupation 90b of behavioral health. In step 86 MatchmakerRating table 44 is read from the database. Each record in the MatchmakerRating table 44 consists of the rating of one client, about one matchmaker for one facet. For example client Tom Jones may rate matchmaker Jamie Taylor as a 7 with regard to facet ‘Meets my goals’. In step 87 only MatchmakerRating records containing FacetIds 45a from step 81, ClientIds 19a from step 83 and MatchmakerIds 98 from step 85 are kept. In step 88 the Ratings in this set of records is divided into groups containing the same FacetId 45a and MatchmakerId 98, for example the FacetId associated with ‘understands my needs’ and the MatchmakerId 98 associated with James Taylor. In step 89, for each group, the Rating 44b FIG. 11 is averaged. In step 90, for each group, the Rating 44b average, the FirstName 99 and LastName 100 (associated with the MatchmakerId 98) and the FacetLabel 45c (associated with the FacetId 45a) are displayed to the client that wants a matchmaker as shown in FIG. 10. For example FirstName 99 LastName 100 Jamie Taylor FacetLable 45c ‘Understands my needs’ and average Rating 44b of 9 34a is one cell of data shown in FIG. 10.

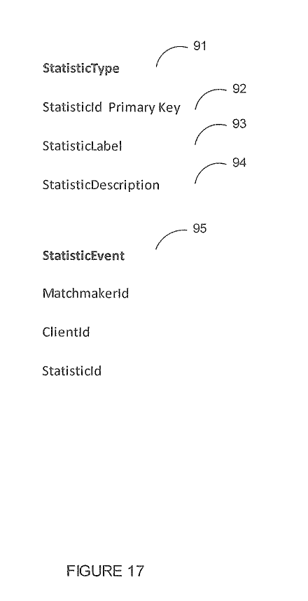

Statistics are gathered in two tables FIG. 17. One table contains statistic types, StatisticType 91. The other table contains statistic events, StatisticEvent 95. A record in the StatisticType table 91 might be Statisticld 92 of 1, StatisticLabel 93 of ‘married’ and StatisticDescription 94 of ‘Client got married’. Each client of a given matchmaker that gets married gets an event in StatisticEvent table 95 containing a MatchmakerId 98, a ClientId 19a and a Statisticld 92. The total number for a statistic, in this example the number of client marriages for a given matchmaker, is acquired by summing the number of married events in the StatisticEvent table 95 for a given MatchmakerId 90a and Statisticld 92. In FIG. 10 this resulted in a marriages 37 entry of 11.

FIG. 13 shows a select of the MatchMakerRating table 44 FIG. 11, Facet table 45 FIG. 11, MatchMaker table FIG. 9 and Profile table 19 FIG. 6, to produce the information necessary to display the matchmaker rating questions 34, 35, 36 shown in FIG. 10. The select is run by the central processing unit, which transforms said table information into data to populate items 34 35 36 of FIG. 10. In this case, the top two matchmakers ‘Jamie Taylor’ and ‘Sally Lamont’ are shown. Within the select we acquire the matchmaker FirstName 55, LastName 56, FactLabel 57 and average rating for matchmakers. The client ratings used, are for clients with Gender 64 male and education 65 college. The aspects of the matchmakers, FacetLabel 63, that we want to list are ‘understands my needs’, ‘provides useful information’ and ‘meets my goals’. We only want to list those matchmakers with an occupation 66 of ‘behavior health’.

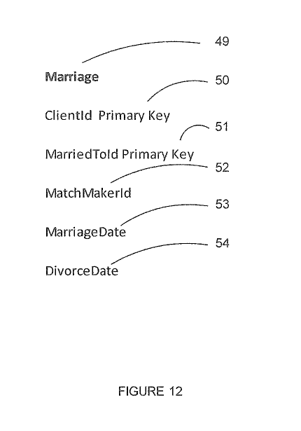

The Marriage 49 table in FIG. 12 holds the information for each client ClientId 50 that has gotten married. MarriedToId 51 is the client that ClientId 50 married. MatchMakerId 52 is the active matchmaker that was working with ClientId 50 at the time of the marriage. The marriage date 52 is saved. The divorce date 53 is saved if there is a divorce. These tables are stored in Client Tables 3 of FIG. 1 and are transformed with the Matchmaker table of FIG. 9 to generate statistics such as 37 of FIG. 10 for a given matchmaker.

An Internet based dating service with matchmakers provides clients an intelligent means of dating suitable individuals and meeting short and long term dating goals. By placing matchmaker ratings in a database, clients can get an understanding of matchmaker strengths and weaknesses. By allowing ratings to be filtered according to desired matchmaker attributes and dating client profile, a clearer picture of a matchmaker's strengths can be determined as it relates to the needs of a given dating client.

Although the description above contains many specificities, these should not be construed as limiting the scope of the invention but as merely providing illustrations of some of the presently preferred embodiments of this invention. Various other embodiments and ramifications are possible within its scope. Thus the scope of the invention should be determined by the appended claims and their legal equivalents, rather than by the examples given.

1. A method for creating a list of matchmakers for use by dating individuals or a matchmaker site, said method comprising:
providing at least one computer having at least one central processing unit;
maintaining at least one database in said computer containing matchmaker identification and matchmaker historical data concerning past success at helping individuals with the dating process;
transforming said matchmaker identification and said historical data by said central processing unit into a list of one or more matchmakers for use by a matchmaker site in choosing matchmakers for the site or for use by dating individuals in choosing a matchmaker to aid them in the dating process.

2. The method of claim 1 further comprising the step of keeping track of the success of said matchmakers on achieving the dating goals of dating individuals and storing these results in said database to generate transformed matchmaker success information for clients to choose matchmakers or the site to offer matchmakers.

3. The method of claim 1 wherein said dating individuals select attributes of said matchmakers.

4. The method of claim 1 wherein said dating individuals select rating types to receive ratings about said matchmakers.

5. The method of claim 1 wherein said dating individuals select attributes of other dating individuals that are used in matchmaker ratings.

6. The method of claim 2 wherein success of said matchmakers include one or more of: client responses to questionnaires; keeping track of how many dates a dating individual has; keeping track of how many exclusive relationships a dating individual has; keeping track of how long exclusive relationships last; determining whether dating individuals get engaged, determining how long engagements last; determining whether dating individuals get married; and determining how long dating individuals stay married.

7. The method of claim 2 further comprising the step of gathering said results and transforming them into a combined form for publishing the matchmaker success to said dating individuals.

8. The method of claim 2 wherein success of said matchmaker is organized by the central processing unit per dating individual group separated by one or more of: age, gender, religion, race, location, partner preference, personality test and education.

9. The method of claim 2 wherein said keeping track of the success of said matchmakers further comprising the step of separating, by the central processing unit, said goals of dating individuals into categories and transforming this information into matchmaker success within goal categories.

10. The method of claim 1 where one or more matchmakers are trained in the field of mental health, such as social workers, psychologists or psychiatrists.

11. The method of claim 1 further including coaching the dating individuals in meeting the short and long term dating goals of the dating individuals, wherein said coaching is in person, through phone or by video-conference.

12. The method of claim 1 wherein a questionnaire built by the matchmaker is used by the dating individuals to rate dates.

13. The method of claim 1 further comprising the step of providing to said dating individuals, over the Internet or in email, videos and books located in said database recommended by said matchmakers.

14. The method of claim 1 where said historical data concerning past success comprises the amount of time paid by dating individuals to the matchmaker.

15. The method of claim 1 where said historical data concerning past success comprises the number of new clients received by the matchmaker, including referrals from dating clients that have used the matchmaker.

16. The method of claim 1 where said historical data concerning past success comprises quotes from dating individuals that have used the matchmaker.

17. The method of claim 1 further comprising the step of recommending books or videos to individuals with similar dating goals based on aggregate recommendations by said matchmakers.

18. The method of claim 1 further comprising the step of storing local activities, parties or vacations in said database, and offering at least one of said local activities, parties and vacations to dating individuals by Internet or email.

19. The method of claim 18 wherein said local activities, parties and vacations are rated based on experience of similar dating individuals and stored in said database.

20. The method of claim 18 wherein said matchmakers recommend activities for dating individuals.

21. The method of claim 20 wherein the success of activity recommendations are based on dating individual survey questionnaires transformed into summarized statistics.

22. The method of claim 20 wherein success of activity recommendations are categorized by the central processing unit per matchmaker.

23. The method of claim 20 wherein the success of activity recommendations are based on transformation of matchmaker survey questionnaires.

24. A system for creating a list of matchmakers for use in a dating process by dating individuals, comprising:
at least one computer having at least one central processing unit and at least one database accessible over the internet;
said database containing the identification of matchmakers that will review information on said dating individuals; and
said database containing matchmaker historical data concerning past success at helping dating individuals with the dating process, said identification of matchmakers and the historical data transformed by said central processing unit into a list of one or more matchmakers for use by a matchmaker site in choosing matchmakers for the site or for use by dating individuals in choosing a matchmaker to aid them in the dating process.

25. A method for selecting a matchmaker by a dating individual for aiding in choosing dates, said method comprising:
providing at least one computer having at least one central processing unit and at least one database accessible over the internet;
maintaining matchmaker identifications for a plurality of matchmakers in at least one said database;
maintaining matchmaker ratings for a plurality of matchmakers in at least one said database;
accessing over the internet by one of said dating individuals said matchmakers to aid said dating individual in choosing dates;
selecting using said central processing unit coupled to said matchmaker identification in said at least one database and said matchmaker ratings in said at least one database, a matchmaker based on ratings of said matchmakers by other dating individuals.
